(19) United States
(12) Patent Application Publication
(10) Pub. No.: US 2020/0309307 A1
(43) Pub. Date: Oct. 1, 2020

(54) Pneumatic Plug System And Method

(71) Applicant: CHERNE INDUSTRIES INCORPORATED, Minneapolis, MN (US)

(72) Inventors: Asim Mohammed Syed, Chanhassen, MN (US); Micah Thomas Olson, Eagan, MN (US)

(21) Appl. No.: 16/806,045

(22) Filed: Mar. 2, 2020

Related U.S. Application Data
(60) Provisional application No. 62/825,213, filed on Mar. 28, 2019.

(51) Int. Cl. F16L 55/11; B65H 18/04

(52) U.S. Cl. CPC F16L 55/1141; B65H 18/145; B65H 18/04

(57) ABSTRACT

An pneumatic plug for sealing a pipeline. The pneumatic plug includes a tubular member that extends in an axial direction from a first end to a second end. The tubular member includes a rubber layer and a fiber layer. The rubber layer extends from the first end to the second end of the tubular member. The fiber layer is disposed on a top surface of the rubber layer. The fiber layer includes a plurality of fibers that extend from the first end to the second end of the tubular member. Each of the plurality of fibers extend at an angle that is offset from the axial direction.

### CROSS-REFERENCE TO RELATED APPLICATIONS

This application claims the benefit of U.S. Provisional Application No. 62/825,213, filed Mar. 28, 2019, the disclosure of which is incorporated by reference herein in its entirety.

### TECHNICAL FIELD

This disclosure relates generally to a pipeline sealing system and, more particularly, to a system and method for pneumatic plugs.

### BACKGROUND

Pipelines are generally known to transport fluids (liquids or gases) over a physical distance within the internal channels of the constituent individual pipe sections. There are multiple situations that require blocking the transport of fluids within the pipeline that include, for example, blocking the flow in an active line, pressure testing of a new installation by blocking ends of the pipeline and pressure testing the space in between, transporting fluid in an active pipeline from one part of the pipeline to another part, temporarily holding back a water surge in a storm pipeline, repairing a downstream section of the pipeline, or for other reasons. In each of these situations, the pipeline is sealed to prevent any fluid or debris from entering the section of the pipeline.

Current systems for sealing pipe sections include the use of pneumatic plugs. For example, the pneumatic plug may be inserted upstream of a damaged pipe section, and inflated. The strength of the plug (e.g. the amount of fluid and debris the plug can withstand within the pipe section) depends upon the material of the plug and how the material is configured. Current pneumatic plugs include layers of rubber forming a tubular body or layers of rubber reinforced with fiber built into the rubber, resulting in pneumatic plugs with limited strength and limited ability to prevent fluid flow within the pipelines.

Therefore, there is a need for a pneumatic plug and method for manufacturing a pneumatic plug having increased strength for performance, reliability, longevity, and consistency within pipelines.

The foregoing background discussion is intended solely to aid the reader. It is not intended to limit the innovations described herein. Thus, the foregoing discussion should not be taken to indicate that any particular element of a prior system is unsuitable for use with the innovations described herein, nor is it intended to indicate that any element is essential in implementing the innovations described herein.

### SUMMARY

The foregoing needs are met, to a great extent, by the pneumatic plug disclosed in the present application. The pneumatic plug includes at least one rubber layer with a fiber layer disposed on an outer surface of the at least one rubber layer. The fiber layer includes a plurality of fibers that extend from a first end of the plug to a second end of the plug in a direction that is offset from a central axis of the plug. The pneumatic plug is manufactured by wrapping an outer surface of a mandrel with a rubber layer, and then wrapping an outer layer of the rubber layer with the fiber layer. The internal surface of the pneumatic plug takes the shape of the outer surface of the mandrel.

An aspect of the present disclosure provides a pneumatic plug. The pneumatic plug includes a tubular member that extends in an axial direction from a first end to a second end. The tubular member includes a rubber layer and a fiber layer. The rubber layer extends from the first end to the second end of the tubular member. The fiber layer is disposed on a top surface of the rubber layer. The fiber layer includes a plurality of fibers that extend from the first end to the second end of the tubular member. Each of the plurality of fibers extend at an angle that is offset from the axial direction.

Another aspect of the present disclosure includes a method for manufacturing a pneumatic plug. The method comprises: disposing a first rubber layer about an outer surface of a mandrel, the first rubber layer extending in an axial direction from a first end to a second end forming a tubular member; and disposing a fiber layer on a top surface of the first rubber layer, the fiber layer including a plurality of fibers extending from the first end to the second end of the tubular member, wherein each of the plurality of fibers is disposed at an angle that is offset from the axial direction; and disposing a second rubber layer about a top surface of the fiber layer, the second rubber layer extending in the axial direction from the first end to the second end of the tubular member.

Another aspect of the present disclosure provides a system for manufacturing a pneumatic plug. The system includes a mandrel having an outer surface that extends from a first end to a second end spaced from the first end along a central axis. Each of the first end and the second end define a first curve and a second curve, respectively. In cross section of the mandrel through the central axis, the first curve and the second curve each define a parametric curve about a first transverse axis and a second transverse axis, respectively. Each of the first and second transverse axes are substantially perpendicular to the central axis.

This summary is provided to introduce a selection of concepts in a simplified form that are further described below in the Detailed Description section. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there are shown in the drawings illustrative embodiments of the disclosure. It should be understood, however, that the application is not limited to the precise arrangements and instrumentalities shown. In the drawings:

FIG. 1 is a perspective view of a pneumatic plug, according to an aspect of this disclosure.

FIG. 2 is a side view of the pneumatic plug shown in FIG. 1, according to an aspect of this disclosure.

FIG. 3 is a perspective view of a middle layer of an end of the pneumatic plug shown in FIG. 1, according to an aspect of this disclosure.

FIG. 4A is a side view of a mandrel, according to an aspect of this disclosure.

FIG. 4B is a side view of the mandrel illustrated in FIG. 4A with a fiber layer disposed about, according to an aspect of this disclosure.

FIG. 5 is a perspective view of a winding device, according to an aspect of this disclosure.

### DETAILED DESCRIPTION

A pneumatic plug used for sealing and repairing pipelines is disclosed. The pneumatic plug is configured to fit within a pipeline and inflate to a predetermined pressure. When the inflatable plug reaches the predetermined pressure, an outer surface of the inflatable plug contacts an inner surface of the pipeline. The contact between the outer surface of the plug and the inner surface of the pipeline forms a substantially fluid tight seal allowing for downstream repair and maintenance. The pneumatic plug comprises a tubular body that includes a rubber layer and a fiber layer that extends about an outer surface of the rubber layer. The fiber layer includes a plurality of fibers that extend in a direction offset from the central axis of the tubular body.

Certain terminology used in this description is for convenience only and is not limiting. The words “axial”, “transverse,” and “radial” designate directions in the drawings to which reference is made. The term “substantially” is intended to mean considerable in extent or largely but not necessarily wholly that which is specified. All ranges disclosed herein are inclusive of the recited endpoint and independently combinable (for example, the range of “from 2 grams to 10 grams” is inclusive of the endpoints, 2 grams and 10 grams, and all the intermediate values). The terminology includes the above-listed words, derivatives thereof and words of similar import.

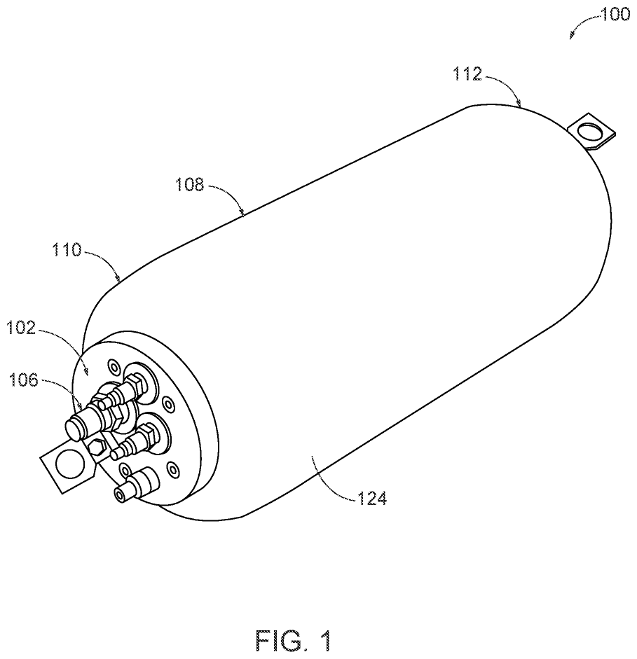

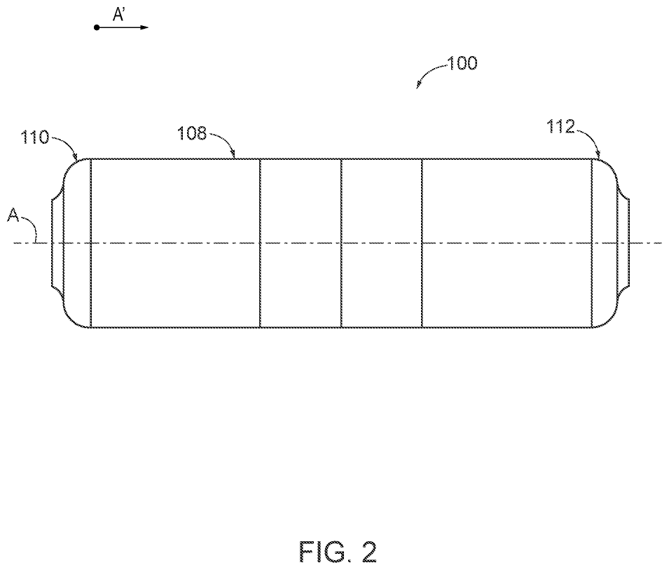

FIG. 1 illustrates a pneumatic plug 100 for sealing a pipeline, and FIG. 2 illustrates a side view of a tubular member 108 of the pneumatic plug 100, according to aspects of this disclosure. The plug 100 is sized and configured to be inserted into a pipeline to a location that is to be sealed. The plug 100 is inflatable to form a tight seal between the plug 100 and with an internal surface area of the pipeline. More particularly, the plug 100 is adapted to wholly or partially contact the internal surface area that extends circumferentially about the interior of the pipeline.

The plug 100 includes a first end plate assembly 102, a second end plate assembly (not visible in figures), a flow-through conduit 106, and the tubular member 108. The plug 100 has a generally cylindrical shape that is elongate along a central axis A, which extends centrally through the plug 100, from a first end 110 to a second end 112. The tubular member 108 and the flow-through conduit 106 are coupled to the first end plate assembly 102 at the first end 110 and coupled to the second end plate assembly at the second end 112.

The plug 100 defines an outer diameter that may be increased upon inflation of the plug 100 to substantially match an inner diameter of a pipeline. The plug 100 is configured to be inflated so as to define a multi-range plug. For example, the plug 100 may be inflated such that the outer diameter of the plug 100 may be increased by 4-6 inches to conform to a range of internal diameters of an inner surface of the pipeline. It will be appreciated that other inflation ranges may be contemplated. Inflating the plug 100 to increase the outer diameter enables the plug 100 to conform to surface irregularities of the inner surface of the pipeline in order to cause uniform sealing.

A single plug size of the plug 100 may accommodate many differently sized pipelines. For example, the plug 100 illustrated in FIG. 1 may accommodate pipelines with inner diameters that range from 8 to 12 inches. In alternative aspects, the plug 100 may be sized to accommodate different sized pipelines by increasing or decreasing the outer diameter of the plug 100. By way of non-limiting example, the plug 100 may be sized to accommodate pipelines that have inner diameters that range from, for example, 4 to 8 inches, 6 to 10 inches, 8 to 16 inches, 12 to 18 inches, 12 to 24 inches, 18 to 24 inches, and 24 to 36 inches.

The flow-through conduit 106 provides an internal passageway through the plug 100. The conduit 106 functions as a bypass to allow a controlled amount of fluid to pass through the plug 100 as needed during a test, repair, or construction operation while utilizing the plug 100. The conduit 106 may be structurally reinforced with a spring member (not shown) so that when the plug 100 is inflated, the conduit 106 will not collapse or otherwise be affected by high pressures within the plug 100.

The first end plate assembly 102 may include a first plate. The first plate may comprise metal, for example, steel, or any other suitable metal having desirable strength characteristics known in the art of inflatable plugs. The first plate may include a plurality of apertures disposed around a periphery of an outer-facing surface of the first plate. The apertures may be configured to receive a plurality of complementary bolts so as to positionally fix the first end plate assembly 102 to the plug 100, and to seal the first end 110 of the plug 100. It will be appreciated that any number of apertures may be included on the first plate for receiving the bolts. It will also be appreciated that the first plate may include no apertures, and may instead include other sealing mechanisms, such as, but not limited to, glues, sealants, clips, fasteners, or other suitable sealing mechanisms known in the art.

The second end 112 of the plug 100 may include the second end plate assembly. The second end plate assembly includes a second plate that has a substantially similar configuration to the first plate. The second plate may also include a plurality of apertures that are configured to receive a plurality of complementary bolts so as to positionally fix the second end plate assembly to the plug 100, and to seal the second end 112 of the plug 100. It will be appreciated that the first plate and the second play may have different configurations depending on, for example, the application or field requirements of the plug 100 such as a blank plate, single large diameter bypass, or other plate configuration.

The first end 110 and the second end 112 of the plug 100 may include elastomeric pads to facilitate the seal of the plug 100 with the first plate and the second plate, respectively. The elastomeric pads may comprise rubber, or any other elastomeric material known in the art that allows for inflation of the plug 100.

The first plate assembly 102 and the second plate assembly may comprise a first inner plate and a second inner plate, respectively, neither of which is visible in the figures. The first and second inner plates are disposed within the interior of the plug 100 at respective first and second ends 110 and 112. The first and second inner plates may be coupled to the first plate and the second plate, respectively, to secure the first end plate assembly 102 and the second end assembly to the tubular member 108. The first and second inner plates may comprise a metal, such as welded steel, or any other suitable metal having similar strength characteristics known in the art.

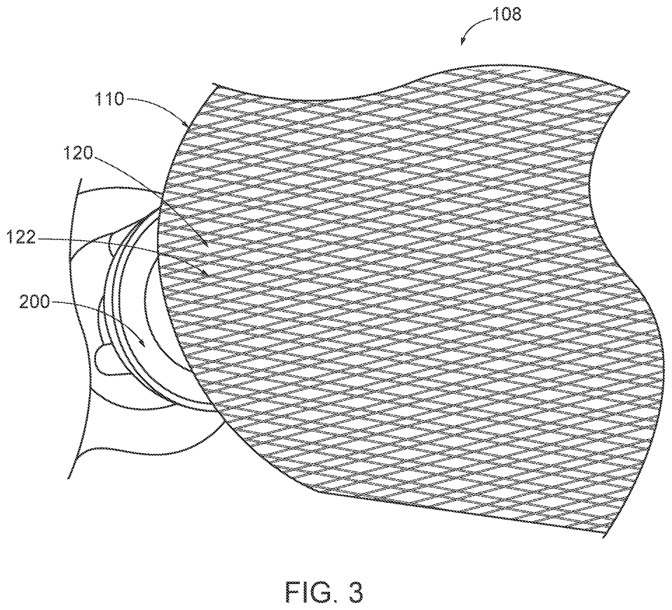

FIG. 3 illustrates a side view of a portion of the tubular member 108 of the first end 110 of the plug 100. The tubular member 108 extends substantially parallel to the axis A from the first end 110 to the second end 112. The tubular member 108 comprises an elastomeric material that includes at least one layer. The at least one layer may include an internal layer 120, a middle layer 122, and an external layer 124. The middle layer 122 is positioned on top of the internal layer 120 such that the middle layer 122 is positioned further radially outward from the axis A than the internal layer 120. Similarly, the external layer 124 is positioned on top of the middle layer 122 such that the external layer 124 is positioned further radially outward from the axis A than the middle layer 122. In an aspect, the elastomeric material comprises rubber. It will be appreciated that the at least one layer may include fewer or more layers.

The plug is formed by disposing the layers 120, 122, and 124 on a top surface of a mandrel 200, such that the layers 120, 122, and 124 are positioned further radially outward from the axis A than the mandrel 200. The mandrel 200 may facilitate the manufacture of the inflatable plug 100, and may be removed either before or after the plug 100 is vulcanized. The mandrel 200 has a cylindrical body that extends between the first end 110 and the second end 112. In an aspect, the mandrel 200 may comprise metal or other material used to facilitate the manufacture of the plug 100.

The internal layer 120 is disposed on top of the mandrel 200 and may comprise a cylindrical body that extends from first end 110 to the second end 112 along an outer surface of the mandrel 200. The internal layer 120 having an inner surface that extends substantially parallel to the central axis A in an axial direction A′ (e.g. first axial direction). The axial direction A′ being substantially parallel to the central axis A and extending in a direction from the first end 110 to the second end 112. The first plate, the second plate, and the inner surface of the internal layer 120 define a central chamber of the plug 100.

An inflation port (not shown) may be selectively inserted into one of the first and second ends 110 and 112 of the plug 100 to provide a passageway into the central chamber. For example, the inflation port may be inserted through the first end plate assembly 102 or the second end plate assembly. The inflation port may be used to fill the central chamber with an inflation medium to inflate the central chamber to a predetermined pressure (e.g., inflation pressure) so that the external layer 124 of the tubular member 108 expands to contact an inner surface of the pipeline. The inflation medium may comprise air, water, or another medium known in the art to cause inflation of plug 100. The predetermined pressure may depend on the size of the plug 100, the size of the pipeline, the structural integrity of tubular member 108, or still other parameters. The predetermined pressure may include a range of pressures between 15 and 45 pounds per square inch (psi). Smaller size plugs 100 may require higher inflation pressure (e.g., 45 psi), and larger size plugs 100 may require smaller inflation pressure (e.g., 15 psi). It will be appreciated, that in some applications, the predetermined pressure may exceed 45 psi.

The middle layer 122 is disposed on top of the internal layer 120 and may comprise a cylindrical body that extends from the first end 110 to the second end 112 of the plug 100. The middle layer 122 may comprise nylon fiber, aramid fiber, or other suitable fiber capable of providing structural integrity to the middle layer 122. The fiber may provide an additional measure of structural integrity to the middle layer 122 when the middle layer 122 is subjected to imbalanced internal or external pressures on the plug 100. The fiber extends from the first end 110 to the second end 112 of the plug 100.

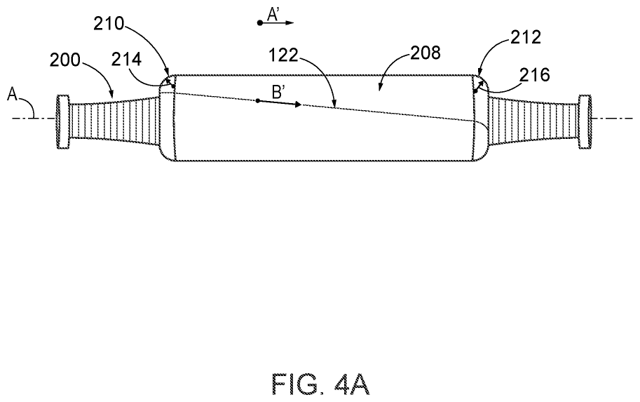

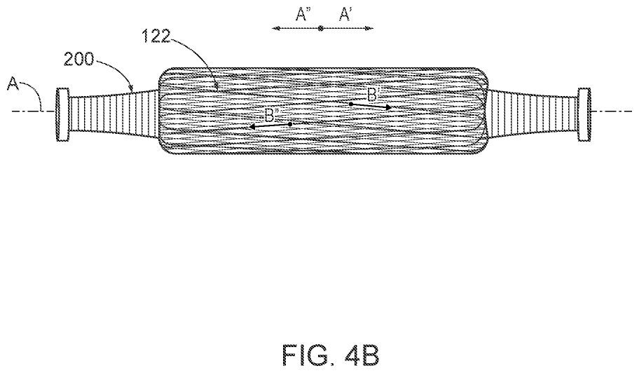

FIGS. 4A and 4B illustrate a side view of the mandrel 200 with the middle layer 122 applied to the outer surface of the mandrel 200. The middle layer 122 of the plug 100 is applied to the outer surface of the internal layer 120 to form the plug 100, however, FIGS. 4A and 4B are meant to illustrate an angle at which the fiber of the middle layer 122 extends from the first end 110 to the second end 112 of the plug 100, and so the fiber is illustrated as being applied to the outer surface of the mandrel 200. The fiber of the middle layer 122 extends along a fiber direction B′ that is offset from the axial direction A′. For example, the fiber of the middle layer 122 may extend from the first end 110 to the second end 112 such that at any point along the fiber, the fiber is extending along the direction B′. In an aspect, the direction B′ is offset from the axial direction A′ at an angle greater than 0 degrees and up to 15 degrees. In an alternative aspect, the direction B′ is offset from the axial direction A′ at an angle between approximately 1 degree and 8 degrees. In another alternative aspect, the direction B′ is offset from the axial direction A′ at an angle between approximately 4 degrees and 7 degrees. In another alternative aspect, the direction B′ is offset from the axial direction A′ at an angle of approximately 5 degrees.

The fiber of the middle layer 122 is disposed around the internal layer 120 and extends from the first end 110 to the second end 112 of the plug 100 in the fiber direction B′, and also extends from the second end 112 to the first end 110 of the plug in a second fiber direction B″. The second fiber direction B″ is offset from a second axial direction A″, which extends in a substantially opposite direction as the axial direction A′. The second fiber direction B″ may be offset from the second axial direction A″ at an angle that is substantially similar to the angle at which the direction B′ is offset from the axial direction A′. For example, if the fiber direction B′ is offset from the axial direction A′ at an angle of approximately 5 degrees, the second fiber direction B″ may be offset from the second axial direction A″ at an angle of approximately 5 degrees.

The external layer 124 is disposed around the middle layer 122 and may comprise a cylindrical body that extends from first end 110 to the second end 112 of the plug 100. The external layer 124 having an outer surface that extends substantially parallel to the central axis A in an axial direction A′.

The plug 100 may include other components that are used in inflatable plugs, such as, for example, additional support rings, elastomeric pads, fasteners, or still other components.

The mandrel 200 includes a mandrel body 208 having a first mandrel end 210 and a second mandrel end 212 spaced from the first mandrel end 210 along the axial direction A′. The first and second mandrel ends 210 and 212 extend circumferentially about the central axis A. The first and second mandrel ends 210 and 212 may include rounded ends, each defining a radius of curvature. For example, when viewing a cross section of the mandrel 200 through the central axis A, the first and second mandrel ends 210 and 212 may define a first radius of curvature 214 and a second radius of curvature 216 about a first transverse axis and a second transverse axis, respectively. The first and second transverse axes extend in a transverse direction that is substantially perpendicular to the axial direction A′. With reference to FIG. 4A, the transverse direction extends out of the page. The first radius of curvature 214 at the first mandrel end 210 may be substantially similar to the second radius of curvature 216 at the second mandrel end 212.

A length of the first and second radius of curvatures 214 and 216 of the mandrel ends varies depending on the size of the mandrel 200. A mandrel 200 that is configured to produce a plug 100 configured to seal a pipeline having a diameter of approximately 12 inches to approximately 24 inches has a first and second radius of curvature 214 and 216 that ranges from approximately 3 inches to approximately 8 inches. A mandrel 200 that is configured to produce a plug 100 configured to seal a pipeline having a diameter of approximately 8 inches to approximately 16 inches has a first and second radius of curvature 214 and 216 that ranges from approximately 2 inches to approximately 7 inches. A mandrel 200 that is configured to produce a plug 100 configured to seal a pipeline having a diameter of approximately 6 inches to approximately 12 inches has a first and second radius of curvature 214 and 216 that ranges from approximately 1 inch to approximately 6 inches. A mandrel 200 that is configured to produce a plug 100 configured to seal a pipeline having a diameter of approximately 4 inches to approximately 8 inches has a first and second radius of curvature 214 and 216 that ranges from approximately 0.1 inches to approximately 5 inches.

In an alternative aspect of the mandrel 200, the rounded ends of the first and second mandrel ends 210 and 212 may each define a parametric curve, defined by four points in space (e.g. Bezier curve), about the first and second transverse axes, respectively. The parametric curve at the first mandrel end 210 may be substantially similar to the parametric curve at the second mandrel end 212, such that the curves are approximate minor images of one another.

The plug 100 is manufactured by disposing the internal layer 120 (e.g. rubber layer) about the outer surface of the mandrel 200. The internal layer 120 extends from the first end 210 to the second end 212 of the mandrel 200. The internal layer 120 may be wound about the outer surface of the mandrel 200 by rotating the mandrel 200 about the central axis A and disposing a strand of the internal layer 120 from the first end 210 to the second end 212 of the mandrel 200 and from the second end 212 to the first end 210 of the mandrel 200. Disposing the internal layer 120 about a rotating mandrel 200 forms an internal layer 120 that has spiral strands that wrap around the mandrel 200. In an aspect, the internal layer 120 is completed when the entire outer surface of the mandrel 200 from the first end 210 to the second end 212 is substantially covered by the strands of the internal layer 120.

The internal layer 120 defines a portion the plug 100. An internal surface of the internal layer 120 has substantially the same shape as the outer surface of the mandrel 200. The configuration (e.g. size and shape) of the plug 100 depends on the configuration of the mandrel 200. For example, the first end 110 and the second end 112 of the plug 100 may be configured substantially similarly to the first mandrel end 210 and the second mandrel end 212 of the mandrel 200. If the rounded ends of the first and second mandrel ends 210 and 212 define parametric curves, then the first and second ends 110 and 112 of the plug include parametric curves.

After the internal layer 120 has been disposed about the mandrel 200, the middle layer 122 (e.g. fiber layer) is disposed on a top surface of the internal layer 120. The middle layer 122 includes a plurality of fibers that extend from the first end 210 to the second end 212 of the mandrel 200. The plurality of fibers form a portion of the tubular member 108 and portions of the first and second ends 110 and 112 of the plug 100. The middle layer 122 may be wound about the top surface of the internal layer 120 by rotating the mandrel 200 about the central axis A and disposing the fibers of the middle layer 122 from the first end 210 to the second end 212 of the mandrel 200 and from the second end 212 to the first end 210 of the mandrel 200. Each fiber is disposed at an angle that extends in the fiber direction B′ from the first end 110 to the second end 112 of the plug 100, and each fiber is disposed at an angle that extends in the second fiber direction B″ from the second end 112 to the first end 110 of the plug 100. It will be appreciated that each fiber disposed about the top surface of the internal layer 120 may overlap one or more fibers.

The fiber directions B′ and B″ that the fibers extend may be selected based on various factors. In an aspect, the fiber directions B′ and B″ may be selected based upon the geometries of the rounded ends of the first and second ends 210 and 212 of the mandrel 200. For example, a ratio between the angle of each of the plurality of fibers (e.g. fiber directions B′ and B″) and the first and second curves of the first and second ends 110 and 112 of the plug 100 may be an inverse ratio. As the radius of curvature for the first and second mandrel ends 210 and 212 increases between mandrels 200, the angles that the fiber directions B′ and B″ extend along decrease. A first mandrel having a larger radius of curvature at the mandrel ends than a second mandrel, would result in selecting fiber directions B′ and B″ that are smaller for the first mandrel compared to the second mandrel.

The fiber directions B′ and B″ that the fibers extend may further be selected based upon a desired friction between the plurality of fibers of the middle layer 122 and the top surface of the internal layer 120. A minimal friction is desired between the middle layer 122 and the internal layer 120, but some friction is needed to provide frictional engagement between the two layers 120 and 122. The fiber directions B′ and B″ that the fibers extend may further be selected based upon a desired tension in each of the plurality of fibers. A lower tension is desired, but some tension is needed for the middle layer 122 to engage the internal layer 120. In an aspect, the desired tension may depend upon the desired friction, and vice versa.

The fiber directions B′ and B″ may be selected based upon other factors, including, for example, the length and diameter of the mandrel 200, inflatable plug 100 size, or still other factors. Each of the factors selected for disposing the middle layer 122 onto the top surface of the internal layer 120 may be selected to maximize a back pressure limit of the plug 100. After selecting the desired factors, the middle layer 122 is disposed on the top surface of the internal layer 120.

After the middle layer 122 has been disposed about the internal layer 120, the external layer 124 (e.g. second rubber layer) is disposed on a top surface of the middle layer 122. The external layer 124 extends from the first end 110 to the second end 112 of the plug 100. The external layer 124 may be wound about the outer surface of the middle layer 122 by rotating the mandrel 200 about the central axis A and disposing a strand of the external layer 124 from the first end 110 to the second end 112 of the plug 100 and from the second end 112 to the first end 110 of the plug 100. Disposing the external layer 124 about a rotating mandrel 200 forms an external layer 124 that has spiral strands that wrap around the middle layer 122. In an aspect, the external layer 124 is completed when the entire outer surface of the middle layer 122 from the first end 110 to the second end 112 is covered by the strands of the external layer 124.

In an alternative aspect, a second fiber layer may be disposed on an outer surface of the external layer 124. The second fiber layer may be disposed on the outer surface of the external layer 124 in a substantially similar manner as the middle layer 122 is disposed on the internal layer 120. In an aspect, the plurality of fibers in the second fiber layer may extend in directions substantially similar to the directions B′ and B″ that the plurality of fibers extend in the middle layer 122. After the second fiber layer has been disposed on an outer surface of the external layer 124, another layer (e.g. third rubber layer) may be disposed on top of the second fiber layer. The third rubber layer may be disposed on a top surface of the second fiber layer in a substantially similar manner as either the internal layer 120 or the external layer 124 are disposed on the mandrel 200 and the middle layer 120, respectively.

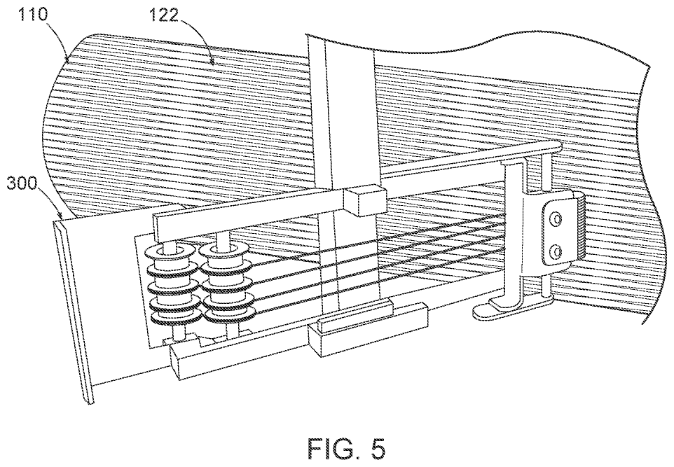

The internal layer 120, the middle layer 122, and the external layer 124 may each be positioned, as described above, by a winding device 300. With reference to FIG. 5, the winding device 300 may be positioned beside the mandrel 200 and move back and forth in the first and second axial directions A′ and A″ while disposing each layer 120, 122, and 124. The winding device 300 may be configured to dispose each layer to form the plug 100 as described above. It will be appreciated that the greater the offset between the fiber directions B′ and B″ that the fibers extend and the first and second axial directions A′ and A″, the greater the winding speed of the winding device 300. For example, the winding device 300 may wind a fiber layer extending at 7° offset from the axial directions A′ and A″ at a greater speed than winding a fiber layer extending at 4° offset from the axial directions A′ and A″.

In an alternative aspect, each layer 120, 122, and 124 may be disposed by different devices. For example, the middle layer may be disposed by the winding device 300, and the internal layer 120 and the external layer 124 may be disposed by another device (e.g. a device configured to dispose rubber layers).

The winding device 300 may compose a system that includes a controller. The controller may be configured to receive input, such as, for example, fiber directions, desired friction, desired tension, mandrel size and dimensions, plug size and dimensions, or still other parameters. Based on the received input, the controller may control the winding device 300 to dispose the layers 120, 122, and 124 about the mandrel 200 to form the plug 100. The controller may include, for example, electronic controllers, system computers, central processing units, or other data storage and manipulation devices known in the art. The controller may be a single unit or may be distributed as a plurality of distinct but interoperating units. The controller may include a processor, a memory, a display or output, an input device, at least one sensor, or combinations thereof.

The inflatable plug 100 is beneficial during an operation to seal the inner surface of the pipeline at the plug 100 location. The curved ends 110 and 112 of the plug 100 and the offset fiber directions B′ and B″ enable the plug 100 to withstand increased back pressure when positioned within a pipeline. When sealing the pipeline, the plug 100 may be inserted into the pipeline, and the central chamber of the plug 100 may be inflated to the predetermined pressure so that the outer surface contacts the inner surface of the pipeline. The contact between the outer surface of the plug 100 and the inner surface of the pipeline creates a substantially fluid tight seal. After the pipeline is sealed by the plug 100, the repair, maintenance, testing, or other activity regarding the pipeline may commence. After the pipeline activity is complete, the central chamber of the plug 100 may be deflated and the plug 100 may be withdrawn from the pipeline. As described above, the plug 100 may be configured and sized to accommodate pipelines that have a wide range of inner diameters.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

What is claimed is:

1. A pneumatic plug for sealing a pipeline, the pneumatic plug comprising:
a tubular member extending in an axial direction from a first end to a second end, the tubular member comprising:
a rubber layer extending from the first end to the second end of the tubular member, and
a fiber layer disposed on a top surface of the rubber layer, the fiber layer including a plurality of fibers extending from the first end to the second end of the tubular member, wherein each of the plurality of fibers extend at an angle that is offset from the axial direction.

2. The pneumatic plug of claim 1, wherein the angle that each of the plurality of fibers extend is between approximately 1 degree and 8 degrees.

3. The pneumatic plug of claim 2, wherein the angle that each of the plurality of fibers extend is between approximately 4 degrees and 7 degrees.

4. The pneumatic plug of claim 1, wherein the first end and the second end of the tubular member extend circumferentially about a central axis, the central axis being substantially parallel to the axial direction, the first end and the second end both defining a parametric curve about a first transverse axis and a second transverse axis, respectively, each of which extend in a transverse direction, the transverse direction being substantially perpendicular to the axial direction.

5. The pneumatic plug of claim 1, wherein the first end and the second end of the tubular member extend circumferentially about a central axis, the central axis being substantially parallel to the axial direction, the first end and the second end both defining a radius of curvature about a first transverse axis and a second transverse axis, respectively, each of which extend in a transverse direction, the transverse direction being substantially perpendicular to the axial direction.

6. The pneumatic plug of claim 5, wherein the radius of curvature ranges from approximately 3 inches to 8 inches for a plug configured to seal a pipeline having a diameter of approximately 12 inches to approximately 24 inches.

7. The pneumatic plug of claim 5, wherein the radius of curvature ranges from approximately 2 inches to 7 inches for a plug configured to seal a pipeline having a diameter of approximately 8 inches to approximately 16 inches.

8. The pneumatic plug of claim 5, wherein the radius of curvature ranges from approximately 1 inches to 6 inches for a plug configured to seal a pipeline having a diameter of approximately 6 inches to approximately 12 inches.

9. The pneumatic plug of claim 5, wherein the radius of curvature ranges from approximately 0.1 inches to 5 inches for a plug configured to seal a pipeline having a diameter of approximately 4 inches to approximately 8 inches.

10. A method for manufacturing a pneumatic plug, the method comprising:
disposing a rubber layer about an outer surface of a mandrel, the rubber layer extending in an axial direction from a first end to a second end forming a tubular member; and
disposing a fiber layer on a top surface of the rubber layer, the fiber layer including a plurality of fibers extending from the first end to the second end of the tubular member, wherein each of the plurality of fibers is disposed at an angle that is offset from the axial direction.

11. The method of claim 10, wherein the angle that each of the plurality of fibers extend is between approximately 1 degree and 8 degrees.

12. The method of claim 11, wherein the angle that each of the plurality of fibers extend is between approximately 4 degrees and 7 degrees.

13. The method of claim 10, wherein the rubber layer is a first rubber layer, the method further comprising:
disposing a second rubber layer about a top surface of the fiber layer, the second rubber layer extending in the axial direction from the first end to the second end of the tubular member.

14. The method of claim 13, wherein the fiber layer is a first fiber layer, the method further comprising:
disposing a second fiber layer on a top surface of the second rubber layer, the second fiber layer extending in the axial direction from the first end to the second end of the tubular member; and
disposing a third rubber layer on a top surface of the second fiber layer, the third rubber layer extending in the axial direction from the first end to the second end of the tubular member.

15. The method of claim 14, wherein the angle that each of the plurality of fibers extend is a first angle, and wherein the second fiber layer includes a second plurality of fibers extending from the first end to the second end of the tubular member, wherein each of the second plurality of fibers is disposed at a second angle that is offset from the axial direction.

16. The method of claim 15, wherein the first angle and the second angle are substantially the same.

17. The method of claim 10, wherein the mandrel has a first mandrel end and a second mandrel end spaced from the first mandrel end along the axial direction, wherein each of the first mandrel end and the second mandrel end define a first curve and a second curve, respectively, the first curve and the second curve extending about a first transverse axis and a second transverse axis, respectively, each of the first and second transverse axes extend in a transverse direction, the transverse direction being substantially perpendicular to the axial direction, the method further comprising:
selecting the angle that each of the plurality of fibers are disposed, wherein selecting the angle is dependent upon geometries of the first curve and the second curve such that a ratio between the angle of each of the plurality of fibers and the first and second curves is an inverse ratio.

18. The method of claim 17, wherein the first curve is substantially symmetric to the second curve such that the first curve is an approximate mirror image of the second curve.

19. The method of claim 10, further comprising:
prior to disposing the fiber layer on the top surface of the rubber layer, selecting a desired friction between each of the plurality of fibers and the rubber layer based upon the angle that each of the plurality of fibers is to be disposed;
prior to disposing the fiber layer on the top surface of the rubber layer, selecting a desired tension in each of the plurality of fibers based upon the desired friction between each of the plurality of fibers and the rubber layer; and
during disposing the fiber layer on the top surface of the rubber layer, disposing each of the plurality of fibers with the desired friction and the desired tension.

20. A system for manufacturing a pneumatic plug, the system comprising:
a mandrel having an outer surface that extends from a first end to a second end spaced from the first end along a central axis, wherein each of the first end and the second end define a first curve and a second curve, respectively, wherein in cross section of the mandrel through the central axis the first curve and the second curve each define a parametric curve about a first transverse axis and a second transverse axis, respectively, each of the first and second transverse axes being substantially perpendicular to the central axis.

21. The system of claim 20, wherein the first curve is substantially symmetric to the second curve such that the first curve is an approximate mirror image of the second curve.

22. The system of claim 20, further comprising:
a winding device configured to dispose a rubber layer about the outer surface of the mandrel, the rubber layer extending from the first end to the second end forming a tubular member, the winding device being further configured to dispose a fiber layer on a top surface of the rubber layer, the fiber layer including a plurality of fibers extending from the first end to the second end of the tubular member, wherein the winding device is configured to dispose each of the plurality of fibers at an angle that is offset from the axial direction.
